(19) United States
(12) Patent Application Publication
(10) Pub. No.: US 2023/0315387 A1
(43) Pub. Date: Oct. 5, 2023

(54) PROCESS COMPUTATIONAL PROBLEM USING SUM-PRODUCT OBJECTIVE FUNCTION

(71) Applicant: Davidson Technologies, Inc., Huntsville, AL (US)

(72) Inventors: Jonathan SEWELL, Huntsville, AL (US); Charles HARTSELL, Madison, AL (US)

(21) Appl. No.: 18/186,633

(22) Filed: Mar. 20, 2023

Related U.S. Application Data
(60) Provisional application No. 63/269,555, filed on Mar. 18, 2022.

(51) Int. Cl. G06F 17/11; G06F 7/544

(52) U.S. Cl. CPC G06F 7/5443; G06F 17/11

(57) ABSTRACT

Various embodiments include systems, methods, and non-transitory computer-readable media for processing a computational problem that embodies, describes, or defines an assignment problem (or any other problem) with an objective function in sum-product form.

### CROSS-REFERENCE TO RELATED APPLICATION

This application claims priority to and the benefit of U.S. Provisional Pat. Application No. 63/269,555, filed on Mar. 18, 2022, which is incorporated herein by reference.

### TECHNICAL FIELD

The present disclosure generally relates to data processing and management. In particular, various embodiments described herein provide systems, methods, techniques, instruction sequences, and devices that use a sum-product objective function to process a computational problem embodying, describing, or defining an assignment problem.

### BACKGROUND

Assignment problems are prevalent in many industries. These problems usually involve a set of assignees (e.g., employees, airplanes, or cargo containers), a set of assignment options for each assignee (e.g., a task, a flight schedule, or a shipping vessel), and an objective function, where the objective function (e.g., an objective function ƒ(x)) provides a score for each assignment between an assignee and an assignment option. Examining a solution space S (e.g., examining the space of all possible sets of assignments of an assignee to zero or one option) to determine an optimal solution (e.g., optimal assignment) to an assignment problem can be too large to explore exhaustively and, as such, determining an absolute optimum cannot be guaranteed.

As an alternative exploring all of the solution space S, the solution space S can be explored in a way that yields near-optimal solutions in a short time by finding one or more assignment solutions that optimize an objective function, which can involve either minimizing or maximizing the objective function. Specifically, the goal of finding an optimal solution to an assignment problem (e.g., optimizing the assignment problem) is to find an input vector x which maximizes or minimizes the value of an objective function f(x). Often assignment problems are constrained, meaning there are one or more properties (e.g., described by constraints property C(x)) that need to be satisfied for a given input vector to be valid. Solving optimization problems usually involves searching a solution space S of all possible input vectors to identify a vector (or multiple vectors if the solution is not unique) that satisfy all required properties and results in an optimal value by the objective function.

### BRIEF DESCRIPTION OF THE DRAWINGS

In the drawings, which are not necessarily drawn to scale, like numerals may describe similar components in different views. To easily identify the discussion of any particular element or act, the most significant digit or digits in a reference number refer to the figure number in which that element is first introduced. Some embodiments are illustrated by way of example, and not limitation, in the figures of the accompanying drawings.

FIG. 1 is a block diagram showing an example networked environment that includes a sum-product-based assignment problem solver, according to various embodiments of the present disclosure.

FIG. 2 is a block diagram illustrating an example sum-product-based assignment problem solver, according to various embodiments of the present disclosure.

FIG. 3 is a graph illustrating an example assignment problem that can be solved by various embodiments of the present disclosure.

FIG. 4 through FIG. 5 are flowcharts illustrating example methods for using a sum-product objective function to process a computational problem embodying, describing, or defining an assignment problem, according to various embodiments of the present disclosure.

FIG. 6 is a block diagram illustrating a representative software architecture, which may be used in conjunction with various hardware architectures herein described, according to various embodiments of the present disclosure.

FIG. 7 is a block diagram illustrating components of a machine able to read instructions from a machine storage medium and perform any one or more of the methodologies discussed herein according to various embodiments of the present disclosure.

### DETAILED DESCRIPTION

The description that follows includes systems, methods, techniques, instruction sequences, and computing machine program products that embody illustrative embodiments of the present disclosure. In the following description, for purposes of explanation, numerous specific details are set forth in order to provide a thorough understanding of embodiments. It will be evident, however, to one skilled in the art that the present inventive subject matter may be practiced without these specific details.

Reference in the specification to “one embodiment” or “an embodiment” means that a particular feature, structure, or characteristic described in connection with the embodiment is included in at least one embodiment of the present subject matter. Thus, the appearances of the phrase “in one embodiment” or “in an embodiment” appearing in various places throughout the specification are not necessarily all referring to the same embodiment.

For purposes of explanation, specific configurations and details are set forth in order to provide a thorough understanding of the present subject matter. However, it will be apparent to one of ordinary skill in the art that embodiments of the subject matter described may be practiced without the specific details presented herein, or in various combinations, as described herein. Furthermore, well-known features may be omitted or simplified in order not to obscure the described embodiments. Various embodiments may be given throughout this description. These are merely descriptions of specific embodiments. The scope or meaning of the claims is not limited to the embodiments given.

Various embodiments described herein provide for using (e.g., optimizing) a sum-product objective function to process a computational problem embodying, describing, or defining an assignment problem, where one or more solutions (e.g., optimal or near-optimal solution) are determined (e.g., identified or found) to the assignment problem. In particular, various embodiments solve an assignment problem representable in the form of an optimization problem with a sum-product objective function (also referred to a sum-product optimization problem) by determining (e.g., identifying or finding) one or more assignment solutions that optimize the sum-product objective function, which can yield optimal or near-optimal solutions for the assignment problem.

For various embodiments, an assignment problem is equivalently framed as a sum-product optimization problem in the form of Error! Reference source not found., which defines the sum-product optimization problem (in minimization form) as:

$$\begin{matrix}{min}_{s ∈ S} o b j \left(s\right) \text{subject to} \\ C \left(s\right) \text{is true,}\end{matrix}$$

where: s is a set of assignments representing a point in the solution space S; obj(s) is sum-product objective function mapping elements in the solution space S to the real numbers ℝ; and C(s) is a property of s describing the satisfaction of various constraints, which can include one or more constraints related to the optimization problem being an assignment problem. An example of a sum-product optimization problem can include abinary sum-product optimization problem, where each assignee of the assignment problem is assigned to at most one option, and where the structure of a binary optimization problem for the assignment problem is implicit in the constraints property C(s). While various embodiments are described herein in terms of minimization (e.g., Equation 1), it will be understood that techniques of embodiments described herein can be applicable to assignment problems stated in minimization or maximization form.

Various embodiments use a sum-product objective function in the form of Equation 2, which defines a sum-product objective function as:

$$o b j \left(s\right) = {\sum }_{i = 1}^{N} {\prod }_{j = 1}^{{M}_{i}} {f}_{i , j} \left(s\right) ,$$

where: s is a set of assignments representing a point in the solution space; obj(s) is the objective function to be optimized; each f_{i,j}(s) is a function that operates on s and produces a non-negative, real-valued score; and N and each Mᵢ are integers defining the sum and product bounds respectively. Additionally, for various embodiments, the natural logarithm of zero and the number e raised to the power negative infinity are defined as ln(0) = -∞ and e^{-∞} = 0, respectively.

Generally, an objective function in sum-product form can be difficult to directly optimize because a direct approach to optimizing a sum-product objective function for an assignment problem would search over all valid assignments without any additional structure. Accordingly, various embodiments described herein decompose an assignment problem formulated with a sum-product objective function into an outer optimization problem and an inner optimization problem, each of which can be more easily designed and optimized. Various embodiments facilitate this decomposition by constraining assignment options of an assignment problem to a partition of assignment options as an intermediate step. This “divide-and-conquer” approach allows various embodiments to trade one large optimization problem for multiple smaller optimization problems which are individually easier to solve.

According to various embodiments, a sum-product objective function is used (e.g., optimized) to process a computational problem embodying, describing, or defining an assignment problem, where one or more solutions (e.g., optimal or near-optimal solution) are determined (e.g., identified or found) to the assignment problem. Specifically, a solution space of a sum-product optimization problem (e.g., a binary sum-product optimization problem) of an assignment problem can be iteratively explored over a sum-product objective function. Partial assignments can be generated across summands of the sum-product objective function of the assignment problem. The sum-product optimization problem can be decomposed into a plurality of optimization subproblems, each of which is a smaller optimization problem, based on a partial assignment across summands. For each individual optimization subproblem, the individual optimization subproblem can be converted to a pseudo-Boolean optimization (PBO) problem, a solution of the PBO problem can be determined, and a solution of the PBO problem can be converted to a solution of the subproblem. Generating a solution for the PBO optimization problem (associated with an individual optimization subproblem) can comprise submitting the PBO optimization problem to a separate process, such as a quantum annealing computer, a quantum circuit model computer, a one-way quantum computer, or a neuromorphic processor. Thereafter, solutions of optimization subproblems can be combined into a solution of the sum-product optimization problem over the sum-product objective function. Eventually, one or more stopping conditions for iterative exploration of the solution space of the sum-product optimization problem can be evaluated and, if satisfied, a solution to the sum-product optimization problem of the assignment problem can be provided.

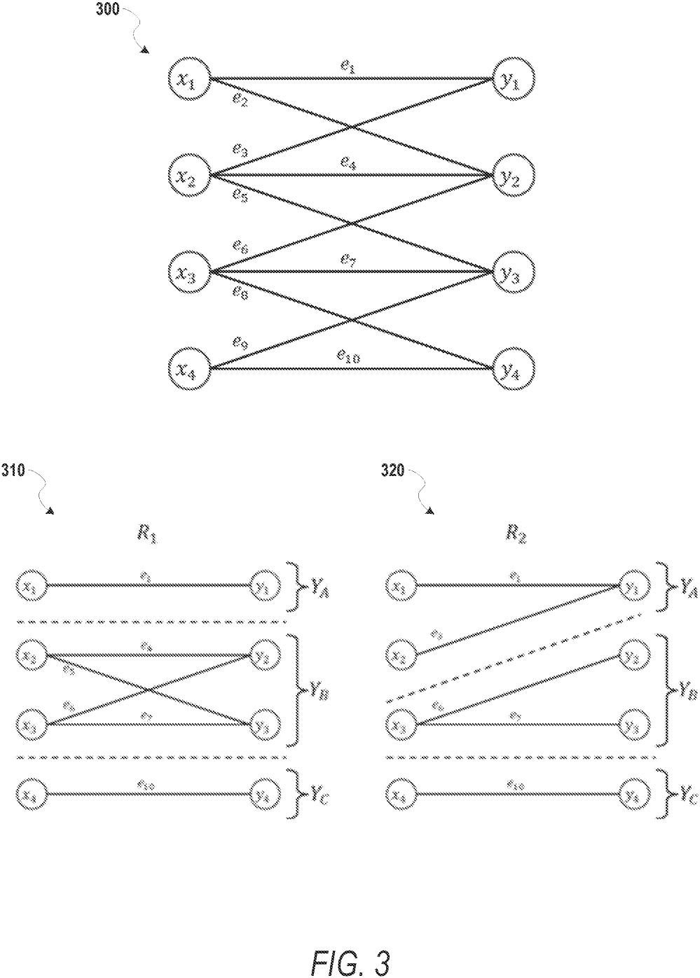

For convenience of explanation, various embodiments are described herein with respect to an example assignment problem illustrated by FIG. 3. Specifically, FIG. 3 is a graph 300 illustrating an example assignment problem that can be solved by various embodiments of the present disclosure. For the illustrated example, there are four assignees. X = {x₁, x₂, x₃, x₄}, and four assignment options, Y = {y₁, y₂, y₃, y₄}. There are a total of ten possible assignments, represented by the edges E = {e₁,e₂, ..., e₁₀}, where each assignment assigns (or maps) one assignee xₖ to one assignment option yⱼ. As noted, this example assignment problem and the corresponding graphical representation is referred to herein to illustrate various embodiments. Various embodiments consider only scenarios where valid solutions have each assignee xₖ assigned to at-most one option yⱼ.

Traditionally, a direct approach to optimizing an objective function for an assignment problem would be to search over all valid assignments without any additional structure. In contrast, some embodiments described herein use a decomposed approach, where such embodiments can first partition assignment options of the example assignment problem of FIG. 3. For example, a plurality of assignment option sets can be determined by partitioning the assignment options (of the example assignment problem) into assignment option sets Y_{A} = (y₁,y₂) and Y_{B} = {y₃, y₄}. Next, for each assignee in X, an embodiment can constrain the assignment options to just those available to the assignee that are within one assignment option set (e.g., a set assignment options within a partition of the assignment options). In the example of FIG. 3, assignees x₁ and x₄ have assignment options that are constrained to one assignment option—specifically, x₁ options are within Y_{A} and x₄ options are within Y_{B}. There are only two constraint choices for each of x₂ and x₃, as they can each be constrained only to Y_{A} or Y_{B}.

The techniques of various embodiments are applicable to (1) any assignment problem that is embodied, described, or defined (e.g., representable) by an optimization problem with a sum-product objective function (hereafter, the sum-product optimization problem) or (2) any optimization problem that satisfies a decomposability property. While various embodiments are described with respect to assignment problems, assignment problems are just one kind of problem processed by techniques described herein. For some embodiments, the techniques described herein can be applied to any optimization problem that satisfies (e.g., meets) a decomposability property. For instance, an optimization problem (e.g., in the form of Equation 1) describing non-assignment problem with a sum-product objective function (e.g., in the form of Equation 2) can be processed by the techniques described herein if the optimization problem can satisfy the decomposability property defined by Equation 3.

Various embodiments described herein can be applied to different types of problems and use cases. For example, an embodiment can be used to determine (e.g., generate) a solution for an assignment problem, such as a flight schedule optimization. For instance, given a list of airplane locations, airplane capabilities, demands for passengers to fly from one location to another at given times, and constraints (e.g., maximum flight time before maintenance is required), an embodiment can be used to determine a flight schedule for each airplane that maximizes the average number of passengers per flight. In another example, an embodiment can be used to determine (e.g., identify) a resource number and a location optimization problem, such as hospital planning for a city. For instance, given a graph consisting of vertices (each of which represents a possible location for a business) and edges (each of which represents the possibility of vehicle transmit between two possible business locations and is associated with a number representing the worst-case transit time required to go between these two locations), and a desired maximum ambulance response time, an embodiment can be used to determine a minimum number of hospitals (and their respective locations) to ensure all locations can be reached by an ambulance starting from a hospital within the desired maximum ambulance response time. In another example, an embodiment can be used to determine (e.g., identify) a resource allocation optimization problem, such as allocation of distinct compute resources to shared computational tasks. For instance, given a set of compute resources with varying capabilities and constraints (e.g., maximum memory available) and a set of computing tasks to be completed, an embodiment can be used to determine how to allocate each compute resource to a specific computing task to minimize the total compute time.

As used herein, a sum-product optimization problem can refer to an optimization problem that is optimized based on a sum-product objective function.

As used herein, a computational problem (or programming problem) can refer to a problem (e.g., data describing a problem) that is configured to be processed by a computer system (e.g., non-quantum computer or a quantum computer) to determine one or more solutions to the problem. For example, a computational problem (e.g., optimization computational problem) can comprise a sub-product optimization problem that embodies, describes, or defines an assignment problem as described herein. A computational problem can comprise a pseudo-Boolean optimization (PBO) problem. A computational problem can comprise a quadratic unconstrained binary optimization (QUBO) problem.

As used herein, a classic computer (also referred to herein as a classic computer device or a classic computer system) refers to a non-quantum computer that operates using a non-quantum processor (e.g., digital hardware processor, such as a general-purpose processor or central processing unit (CPU)), which processes information as bits. As used herein, a quantum computer-based solver comprises, or is implemented using, a quantum computer. A quantum computer (also referred to as a quantum computing device or a quantum computer system) can comprise physical computer/computational hardware that perform computational tasks using quantum technology (e.g., at least one quantum hardware processor) that leverages quantum physics and quantum phenomena to process information (e.g., binary information) via one or more qubits. A qubit is a basic unit of information in a quantum computer, and is generally implemented by a physical circuit or device that operates using the quantum physics principles of superposition (which permits a qubit to have a quantum state representing a superposition of two values (e.g., 0 and 1) simultaneously), entanglement (which permits the state of the qubit (e.g., state of being a superposition of 1 and 0) being dependent on the state of another qubit), or both. There are different types of quantum computers, and the architecture and physical implementation of a qubit can differ between different types of quantum computer and their respective manufacturers. For instance, examples of different types of qubits include, without limitation, superconducting qubits, photonic qubits, trapped ion qubits, topological qubits, quantum dot qubits, and nuclear magnetic resonance qubits. Examples of a quantum computer can include, without limitation, a quantum annealing computer (also referred to as a quantum annealer) or a universal gate quantum computer (which comprises one or more quantum logic gates or circuits that can be interconnected to form a quantum circuit to perform one or more logic operations on a qubit). Depending on the embodiment, a quantum computer used for various operations as described herein can form part of a non-quantum computer (e.g., quantum co-processor) or can be external to a non-quantum computer and operatively coupled to the non-quantum computer (e.g., by way of an electronic connection). For some embodiments, a quantum computer used herein is provided over a network (e.g., use/access of the quantum computer can be provided by a cloud-based computing resource, a quantum processing platform, or as software as a service). Alternatively, or additionally, the quantum computer can be implemented as local hardware (e.g., quantum co-processor) that is a part of a non-quantum computer configured to perform non-quantum computer operations in accordance with an embodiment

Though various embodiments are described herein as using a quantum computer (e.g., quantum computer-based solver) to perform certain operations (e.g., solving PBO problems), it will be understood that other embodiments can use an alternative form of computing hardware for perform operations described herein, such as a neuromorphic processor-based, a graphic processing unit (GPU)-based, or a general purpose computer processor (e.g., central processing unit (CPU) or digital processor)-based solver.

Reference will now be made in detail to embodiments of the present disclosure, examples of which are illustrated in the appended drawings. The present disclosure may, however, be embodied in many different forms and should not be construed as being limited to the embodiments set forth herein.

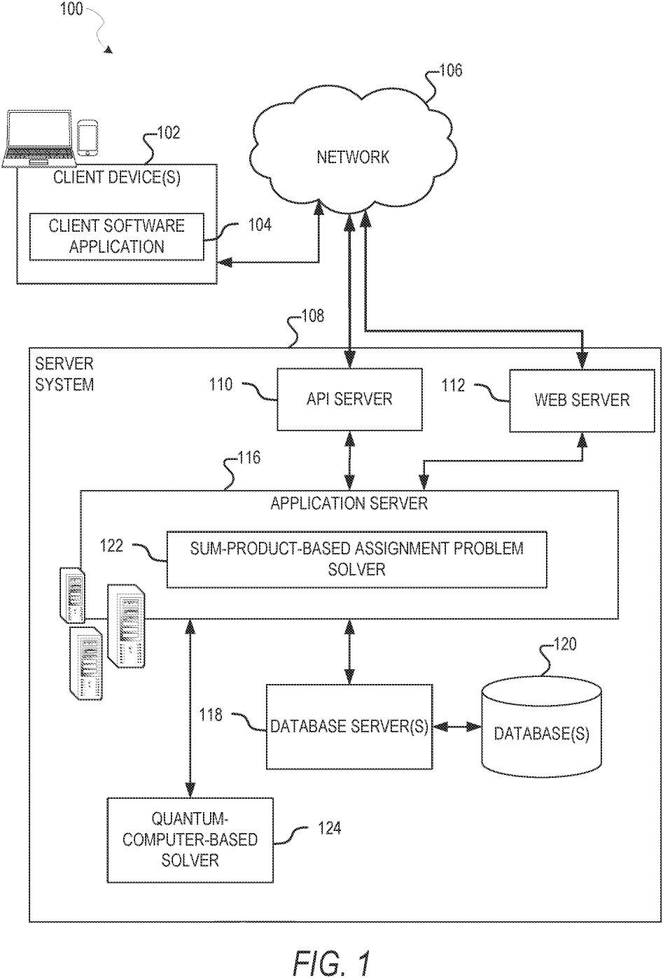

FIG. 1 is a block diagram showing an example networked environment 100 that includes a sum-product-based assignment problem solver 122, according to various embodiments of the present disclosure. By including the sum-product-based assignment problem solver 122 (hereafter, the SP-based assignment problem solver 122), the networked environment 100 can use (e.g., optimize) a sum-product objective function to process a computational problem embodying, describing, or defining an assignment problem, where one or more solutions (e.g., optimal or near-optimal solution) are determined (e.g., identified or found) to the assignment problem. For instance, a user at the client device 102 can access the SP-based assignment problem solver 122 and cause the SP-based assignment problem solver 122 to use a sum-product objective function to process a computational problem of an assignment problem to determine one or more solutions to the assignment problem.

As shown, the networked environment 100 includes one or more client devices 102, a server system 108, and a network 106 (e.g., including the Internet, wide-area-network (WAN), local-area-network (LAN), wireless network, etc.) that communicatively couples them together. Each client device 102 can host a number of applications, including a client software application 104. The client software application 104 can communicate data with the server system 108 via a network 106. Accordingly, the client software application 104 can communicate and exchange data with the server system 108 via network 106.

The server system 108 provides server-side functionality via the network 106 to the client software application 104. While certain functions of the networked environment 100 are described herein as being performed by the SP-based assignment problem solver 122 on the server system 108, it will be appreciated that the location of certain functionality within the server system 108 is a design choice. For example, it may be technically preferable to initially deploy certain technology and functionality within the server system 108, but to later migrate this technology and functionality to the client software application 104.

The server system 108 supports various services and operations that are provided to the client software application 104 by the SP-based assignment problem solver 122. Such operations include transmitting data from the SP-based assignment problem solver 122 to the client software application 104, receiving data from the client software application 104 to the SP-based assignment problem solver 122, and the SP-based assignment problem solver 122 processing data generated by the client software application 104. This data may include, for example, requests and responses relating to processing a computational problem embodying, describing, or defining an assignment problem. Data exchanges within the networked environment 100 may be invoked and controlled through operations of software component environments available via one or more endpoints, or functions available via one or more user interfaces of the client software application 104, which may include web-based user interfaces provided by the server system 108 for presentation at the client device 102.

With respect to the server system 108, each of an Application Program Interface (API) server 110 and a web server 112 is coupled to an application server 116, which hosts the SP-based assignment problem solver 122. The application server 116 is communicatively coupled to a database server 118, which facilitates access to a database 120 that stores data associated with the application server 116, including data that may be generated or used by the SP-based assignment problem solver 122.

The API server 110 receives and transmits data (e.g., API calls, commands, requests, responses, and authentication data) between the client device 102 and the application server 116. Specifically, the API server 110 provides a set of interfaces (e.g., routines and protocols) that can be called or queried by the client software application 104 in order to invoke functionality of the application server 116. The API server 110 exposes various functions supported by the application server 116 including, without limitation: user registration; login functionality; data object operations (e.g., generating, storing, retrieving, encrypting, decrypting, transferring, access rights, licensing, etc.); and user communications.

Through one or more web-based interfaces (e.g., web-based user interfaces), the web server 112 can support various functionality of the SP-based assignment problem solver 122 of the application server 116.

The application server 116 hosts a number of applications and subsystems, including the SP-based assignment problem solver 122, which supports various functions and services with respect to various embodiments described herein. The application server 116 is communicatively coupled to a database server 118, which facilitates access to database(s) 120 that stores data associated with the SP-based assignment problem solver 122.

According to various embodiment, the SP-based assignment problem solver 122 accesses, or makes use of, a quantum computer-based solver 124 to perform one or more operations for determining a solution (e.g., a complete combinatorial solution) for a computational problem embodying, describing, or defining an assignment problem. Depending on the embodiment, the SP-based assignment problem solver 122 can be implemented using (e.g., comprises) a quantum computer, such as a quantum annealer, or a universal gate quantum computer. During operation, the SP-based assignment problem solver 122 can access a first computational problem comprising a sum-product optimization problem that embodies, describes, or defines an assignment problem comprising a plurality of assignees and a plurality of assignment options. For instance, the first computational problem (e.g., data describing the first computational problem) can be submitted by one of the client devices 102 to the SP-based assignment problem solver 122 (e.g., by way of the API server 110 or the web server 112) for one or more solutions. In response to the submission (or an instruction from the client device 102), the SP-based assignment problem solver 122 can access the first computational problem (e.g., the submitted data describing the first computational problem).

To process the first computational problem and determine a solution (e.g., close to optimal solution) for the assignment problem, the SP-based assignment problem solver 122 can: determine a plurality of assignment option sets from the plurality of assignment options of the assignment problem; determine a set of restrictions for the assignment problem (where each restriction constrains each assignee of the plurality of assignees to an individual assignee option set of the plurality of assignment option sets); perform (e.g., execute) one or more iterations of processing and solving computational subproblems (determined from the sum-product optimization problem) based on the set of restrictions; and determining a solution for the assignment problem (e.g., most optimal solutions) based on the solutions determined (e.g., generated) for the computational subproblems.

As described herein, the SP-based assignment problem solver 122 can process the first computation problem and determine one or more solutions for the assignment problem of the first computation problem by using a solver. For instance, the SP-based assignment problem solver 122 can use the quantum computer-based solver 124 (e.g., implemented by a quantum annealer or a universal gate quantum computer) to solve one or more of the computational subproblems (e.g., PBO problems thereof) determined from the sum-product optimization problem based on the set of restrictions. Alternatively, the solve used by the SP-based assignment problem solver 122 can be implemented using other computing technologies, such as digital annealing computer (e.g., digital annealer), a neuromorphic processor-based computer, a GPU-based computer, a high-performance compute (HPC) computer, and the like.

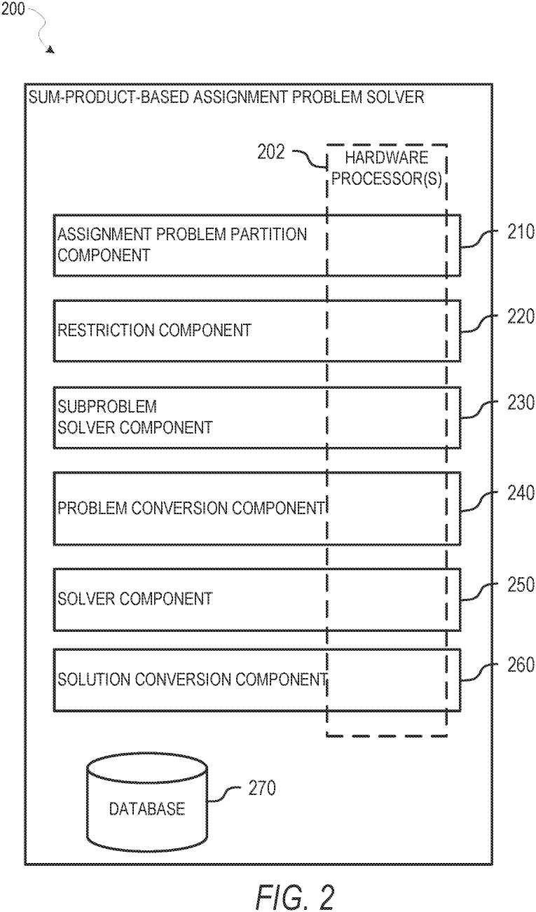

FIG. 2 is a block diagram illustrating an example sum-product-based assignment problem solver 200, according to various embodiments of the present disclosure. For some embodiments, the sum-product-based assignment problem solver 200 (hereafter, the SP-based assignment problem solver 200) represents an example of the SP-based assignment problem solver 122 described with respect to FIG. 1. As shown, the SP-based assignment problem solver 200 comprises an assignment problem partition component 210, a restriction component 220, a subproblem solver component 230, a problem conversion component 240, a solver component 250, and a solution conversion component 260. According to various embodiments, the assignment problem partition component 210 facilitates determining (e.g., partitioning) a plurality of assignment options of an assignment problem into a plurality of assignment option sets (e.g., each assignment option set comprises one or more assignment options from the plurality of assignment options), the restriction component 220 facilitates determining a set of restrictions for an assignment problem embodied, described, or defined by a sum-product optimization problem of a computational problem, the subproblem solver component 230 facilitates determining subproblems (e.g., optimization subproblems) from an optimization problem (e.g., sum-product optimization problem) and facilitates solving of each subproblem, the problem conversion component 240 facilitates conversion (e.g., transformation) of a computational problem (e.g., comprising an inner optimization problem of a restriction optimization problem) to another computational optimization problem (e.g., PBO problem), the solver component 250 facilitate using a solver (e.g., the quantum computer-based solver 124) to determine a solution to a optimization problem (e.g., PBO or QUBO problem), and the solution conversion component 260 facilitate combining of subproblem solutions and converting of solutions (e.g., transforming a PBO solution to an inner optimization problem solution ). Data generated by one or more of the components 210 through 260 can be stored in a database 270 of the SP-based assignment problem solver 200.

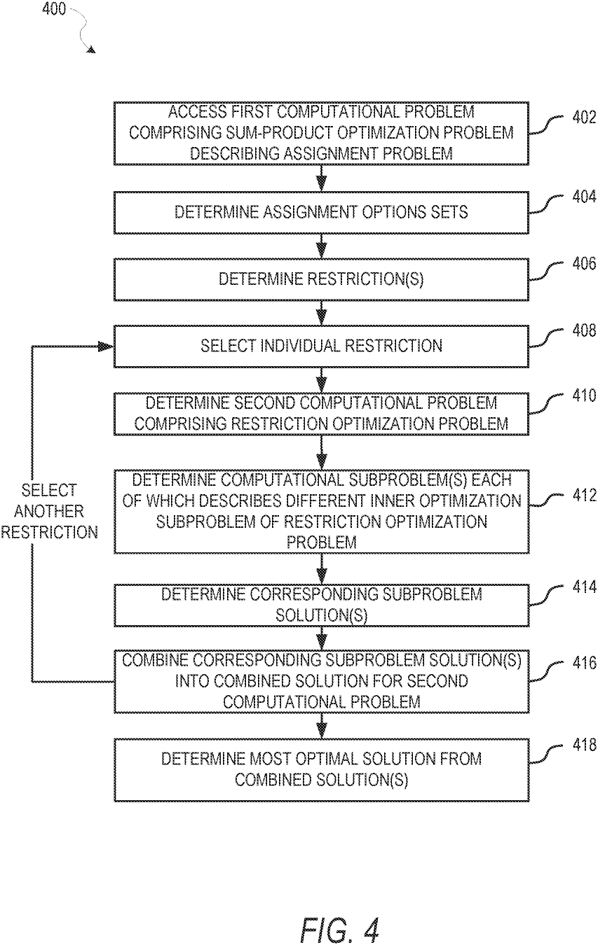

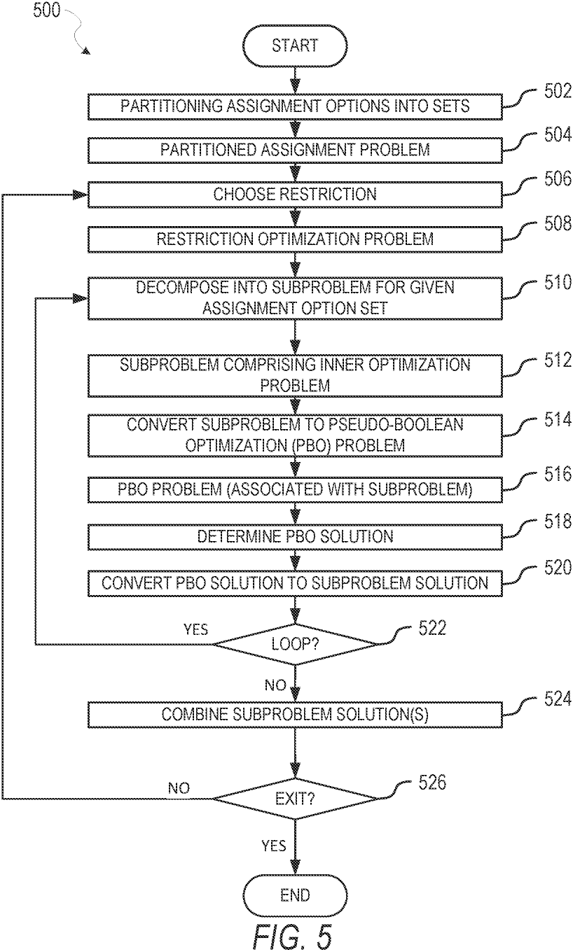

FIG. 4 through FIG. 5 are flowcharts illustrating example methods 400, 500 for using a sum-product objective function to process a computational problem embodying, describing, or defining an assignment problem, according to various embodiments of the present disclosure. It will be understood that example methods described herein may be performed by a machine in accordance with some embodiments. For example, method 400 or method 500 can be performed by the SP-based assignment problem solver 122 described with respect to FIG. 1, the SP-based assignment problem solver 200 described with respect to FIG. 2, or individual components thereof. An operation of various methods described herein may be performed by one or more hardware processors 202 (e.g., digital hardware processors, such as central processing units (CPUs) or graphics processing units (GPUs)) of a computing device (e.g., a desktop, server, laptop, mobile phone, tablet, etc.), which may be part of a computing system based on a cloud architecture. Example methods described herein may also be implemented in the form of executable instructions stored on a machine-readable medium or in the form of electronic circuitry. For instance, the operations of method 400 or method 500 may be represented by executable instructions that, when executed by a digital hardware processor of a computing device, cause the computing device to perform the method 400 or the method 500. Depending on the embodiment, an operation of an example method described herein may be repeated in different ways or involve intervening operations not shown. Though the operations of example methods may be depicted and described in a certain order, the order in which the operations are performed may vary among embodiments, including performing certain operations in parallel.

Referring now to method 400 of FIG. 4, at operation 402, a digital hardware processor accesses a first computational problem comprising a sum-product optimization problem that embodies, describes, or defines an assignment problem, where the assignment problem comprises a plurality of assignees and a plurality of assignment options. The graph 300 of FIG. 3 illustrates an example of an assignment problem with four assignees, X = {x₁, x₂, x₃, x₄ }, and four assignment options, Y = {y₁, y₂, y₃, y_{4}}. As described herein, data describing the first computational problem can be submitted (e.g., by a client device to solver of an embodiment) for a solution. In response to the submission, the digital hardware processor can perform operation 402. For some embodiments, the sum-product optimization problem can be defined by Equation 1 and have a sum-product object function defined by Equation 2.

Thereafter, at operation 404, the digital hardware processor determines a plurality of assignment option sets from (e.g., by partitioning) the plurality of assignment options. This determination (e.g., partitioning) can be performed once and may not change during execution of the method 400. Each of the assignment option sets can be a partite set. For example, referring to our example in FIG. 3, the plurality of assignment options can be portioned into assignment option sets Y_{A} = {y₁}, Y_{B} = {Y₂, Y₃}, and Y_{C} = {y₄} as shown by graphs 302 and 304 of FIG. 3. For instance, P = {P₁, P₂, ..., Pᵢ, ..., P_{N}} can represent a partition of choices (e.g., P = {Y_{A}, Y_{B}, Y_{C}} is the partition of choices in the above example). Any technique can be used to determine the partitioning the plurality of assignment options into the plurality of assignment option sets, such as random choice, a machine-learning (ML) model, or an application-specific technique. For some embodiments, the determining the plurality of assignment option sets from the plurality of assignment options based on a decomposability property. For instance, the chosen partitioning of the plurality of assignment options (of the assignment problem of the sum-product optimization problem) can be compatible with the decomposability property.

At operation 406, the digital hardware processor determines a set of restrictions for the assignment problem, where each restriction of the set of restrictions constrains each assignee of the plurality of assignees to an individual assignee option set of the plurality of assignment option sets. For instance, each restriction (in the set of restrictions) can constrain each assignee of the plurality of assignees to exactly one of the plurality of assignment option sets. Accordingly, a restriction can restrict possible assignments of each assignee to assignment options in a single partition. For a given partitioning of the assignment options (by operation 404), there are typically multiple ways the set of restrictions can be determined. For instance, as illustrated by graph 310 in FIG. 3, an example restriction R₁ restricts x₁ to Y_{A}, x₂ and x₃ to Y_{B}, and x₄ to Y_{C}, and as illustrated by graph 320 in FIG. 3, an example restriction R₂ restricts x₁ and x₂ to Y_{A}, x₃ to Y_{B}, and x₄ to Y_{C}. With respect to the partition choices P described above, ℜ(P) can represents the collection of all valid sets of constraint choices relative to partition P. Si (R) can represent the collection of all valid sets of assignments restricted to constraint choices within R and the i^{th} assignment option set of P. For example, as shown by graph 310 of FIG. 3, S_{A} (R₁) refers to the set of all valid assignments within the Y_{A} partition of restriction R₁, which in this case comprises two options: either (1) x₁ is assigned to y₁ - corresponding to edge e₁ - or (2) no assignments are made. For each of these example restrictions, certain assignment options that do not respect the restrictions (visually represented by edges which cross the dotted lines in FIG. 3) have been eliminated from the graphs 310, 320.

Subsequently, the digital hardware processor determines a set of combined solutions for the first computational problem by iteratively performing operations 408 through 416. For various embodiments, performing operation 408 through 416 effectively decomposes the first computational problem based on the set of restrictions into a plurality of computational subproblems, determines a subproblem solution for each computational subproblem, and then combines the subproblem solutions that result.

For operation 408, the digital hardware processor selects an individual restriction from the set of restrictions. For some embodiments, the individual restriction is selected using any suitable method, such a random choice, a machine-learning model, or another well-known optimization technique (e.g., branch-and-bound). For iteration (of operations 408 through 416) performed, restrictions that have already been examined on previous iterations are not considered again. For instance, if the example restriction R₁ is selected on the initial iteration, the example restriction R₂ can be selected on the second iteration.

At operation 410, the digital hardware processor determines, from the first computational problem, a second computational problem comprising a restriction optimization problem for the individual restriction. Specifically, the following Equation 3 defines a decomposability property that can be satisfied by the sum-product objective function (e.g., Equation 2) of the sum-product optimization problem being processed by the method 400:

$${min}_{s ∈ S} {\sum }_{i = 1}^{N} {\prod }_{j = 1}^{{M}_{i}} {f}_{i , j} \left(s\right) = {min}_{R ∈ ℜ \left(P\right)} {\sum }_{i = 1}^{N} {min}_{s ∈ {S}_{i} \left(R\right)} {\prod }_{j = 1}^{{M}_{i}} {f}_{i , j} \left(s\right) .$$

Based on Equation 3 being satisfied by the sum-product optimization problem being processed by the method 400 (e.g., as defined by Equation 1), then the sum-product optimization problem can be decomposed to the following Equation 4:

$$\begin{matrix}{min}_{R ∈ ℜ \left(P\right)} {\sum }_{i = 1}^{N} {min}_{s ∈ {S}_{i} \left(R\right)} {\prod }_{j = 1}^{{M}_{i}} {f}_{i , j} \left(s\right) \text{subject to} \\ C \left(s\right) \text{is true} \text{.}\end{matrix}$$

Various embodiments described herein can process a computational problem that includes an optimization problem that is either: (1) is represented in the form of Equation 4 or (2) is represented in the form Equation 1 and satisfies the decomposability property of Equation 3.

By applying Equation 4 to the sum-product optimization problem (being processed by the method 400) over all possible restrictions from the set of restrictions results in a restriction objective function as defined by the following Equation 5:

$$o b {j}_{r e s} \left(R\right) = {\sum }_{i = 1}^{N} {min}_{s ∈ {S}_{i} \left(R\right)} {\prod }_{j = 1}^{{M}_{i}} {f}_{i , j} \left(s\right) .$$

and a restriction optimization problem for the sum-product optimization problem as defined by the following Equation 6:

$$\begin{matrix}{min}_{R ∈ ℜ \left(P\right)} o b {j}_{r e s} \left(R\right) \text{subject to} \\ C \left(s\right) \text{is true} \text{.}\end{matrix}$$

During operation 412, the digital hardware processor determines, from the second computational problem, a set of computational subproblems each of which describes a different inner optimization subproblem of the restriction optimization problem that corresponds to a different one of the plurality of assignment option sets (e.g., different partite set, such as Y_{A}, Y_{B}, and Y_{C}). In doing so, operation 412 can decompose the restriction optimization problem from operation 410 to multiple subproblems. Specifically, the outer portion of the objective function defined by Error! Reference source not found. comprises a summation of optimization subproblems of the restriction optimization problem (currently being processed by the iteration) and, according to various embodiments, each of those optimization subproblems can be extracted to define a different, individual inner optimization subproblem of the restriction optimization problem (which can be processed and solved during operation 414). For some embodiments, a given inner optimization problem searches for a best set of assignments subject to constraints given in of the individual restriction (selected by operation 406) and relative to an inner objective function. In particular, the inner objective function can be defined by the following Equation 7:

$$o b {j}_{i m} \left(i , s\right) = {\prod }_{j = 1}^{{M}_{i}} {f}_{i , j} \left(s\right) ,$$

and the (complete) inner optimization problem can be defined by the following Equation 8:

$$\begin{matrix}{min}_{s ∈ {S}_{i} \left(R\right)} o b {j}_{i n} \left(i , s\right) \text{subject to} \\ C \left(s\right) \text{is true} \text{.}\end{matrix}$$

At operation 414, the digital hardware processor determines a set of subproblem solutions for the set of computational subproblems. For some embodiments, operation 414 determines the set of subproblem solutions iteratively by selecting an individual assignment option set (e.g., partite set Yᵢ) and determining a solution for the inner optimization problem (e.g., as defined by Equation 8) that corresponds to the selected individual assignment option set. An individual assignment option set can be selected using any suitable method, such as random choice or a machine-learning (ML) model. Subsequent iterations can be performed similarly, an individual assignment option set that has already been examined on a prior iteration is not considered again. For example, operation 414 can select to examine the (currently) selected restriction with respect to Y_{A} on an initial iteration, and then the (currently) selected restriction with respect to Y_{B} on a second iteration.

For some embodiments, operation 414 comprises determining, based on the individual computational subproblem, a third computational problem that describes a pseudo-Boolean optimization (PBO) problem (e.g., converting the inner optimization problem to the PBO problem), and solving the PBO problem to determine an individual subproblem solution of the set of subproblem solutions that corresponds to the individual computational subproblem. After a solution to the PBO problem is determined, the PBO problem solution can be converted to an inner optimization problem solution, which represents an individual subproblem solution in the set of subproblem solutions.

For some embodiments, determining the third computational problem based on the individual computational subproblem comprises associating a binary variable with each possible assignment of an assignee, of an inner optimization subproblem of the individual computational subproblem, to an assignment option of the inner optimization subproblem. Then, for each assignment option of the inner optimization subproblem: a set of terms can be determined by determining a term for each combination of assignees that can be assigned to the assignment option; and the set of terms that result can be combined by adding coefficients for terms of the set of terms that have like associated binary variables.

For some embodiments, solving the PBO problem comprises applying an optimization technique for constrained optimization of the PBO problem. For example, solving the PBO problem can comprise using a quantum computer-based solver to solve the PBO problem, where the quantum computer-based solver can be implemented using a quantum annealer or a universal gate quantum computer. For various embodiments, using the quantum computer-based solver to solve the PBO problem comprises: converting the third computational problem to a computational problem that comprises a quadratic unconstrained binary optimization (QUBO); and submitting the computational problem to the quantum computer-based solver to generate the optimized solution. For instance, an embodiment can submit the computational problem to the quantum computer-based solver (e.g., 124) to generate the optimized solution for the QUBO by mapping variables of the QUBO problem to physical qubit circuits of the quantum computer-based solver. As another example, solving the PBO problem can comprise using at least one of a simulated annealing technique or a neighborhood search technique to solve the PBO problem.

For operation 416, the digital hardware processor combines the set of subproblem solutions to determine a combined (or complete) solution for the second computational problem (of the current iteration). In particular, each individual inner optimization problem solution can be combined into one complete solution that comprises all assignment option sets (e.g., all partite sets) for the (current) selected restriction (selected by operation 408). This combined solution can represent one complete evaluation of the restriction objective function objres(R) presented in Equation 5. At end of operation 416, if any restrictions in the set of restrictions still need consideration by an iteration (of operations 410-416), then the method 400 returns to operation 408 and selects another (remaining) restriction from the set of restrictions. If, however, all restrictions of the set of restrictions have been considered, the method 400 proceeds to operation 418, where the digital hardware processor determines (e.g., identifies or provides) an optimal solution from a set of combined (or complete) solutions that each result from performing operation 416 (over one or more iterations).

Eventually, at operation 418, the digital hardware processor determines (e.g., selects or identifies) an optimal solution from the set of combined solutions, which can represent an optimal or near-optimal solution for the assignment problem described by the sum-product optimization problem of the first computational problem (accessed by operation 402). For some embodiments, the optimal solution that is determined (e.g., identified or provided) represents the most optimal combined (or complete) solution identified during any iteration. The optimality of a given combined (or complete) solution can be determined based on its score as determined by the sum-product objective function.

More regarding operations of the method 400 are described with respect method 500 of FIG. 5.

Referring now to method 500 of FIG. 5, the method 500 is an example implementation of the method 400 of FIG. 4. At the start, a digital hardware processor performs operation 502, where partitioning of assignment option sets is performed by grouping the assignment options of the assignment problem into individual groups (e.g., partite sets). For various embodiments, the assignment problem is embodied, described, or defined by a sum-product optimization problem (e.g., Equation 1). As described herein, this partitioning can be performed once and may not change during execution of the method 500. The effective output of operation 502 is a partitioned assignment problem 504 (e.g., represented by Y_{A}, Y_{B}, Y_{C} in FIG. 3).

During operation 506, the digital hardware processor chooses a restriction (e.g., assignment-to-partition restriction) by restricting each assignee to exactly one of the assignment option sets (e.g., partite sets) defined by operation 502. As described herein, many different restrictions can be possible. While a single restriction can be initially chosen by operation 506, operation 506 represents a beginning of a loop that can consider all possible restrictions. The output of operation 506 is a restriction optimization problem 508 (e.g., Equation 6). Once a restriction is chosen, and a set of constraint choices relative to a partition have been made based on the chosen restriction, the sum-product optimization problem (describing the assignment problem) can be decomposed into one or more subproblems. For example, if restriction R₁ is chosen, then the assignees can be optimized in three independent groups: (1) x₁, (2) x₂ and x₃, and (3) x₄.

At operation 510, the digital hardware processor decomposes the restriction optimization problem 508 into subproblems for the chosen restriction, where each subproblem corresponds to a different assignment option set (e.g., different partite set) and where each subproblem a different inner optimization problem (e.g., Equation 8) of the restriction optimization problem 508. For example, during operation 510, a given assignment option set can be selected and the restriction optimization problem 508 can be selected to subproblem 512 comprising an inner optimization problem (also referred herein to as an inner optimization subproblem) based on the selected individual assignment option set. There can be multiple assignment option sets (e.g., partite sets) to be considered and selected from. While a single assignment option set can be selected initially by operation 510, operation 510 represents a beginning of a loop that can consider all assignment option sets (e.g., all partite sets). The output of operation 510 is the subproblem 512 for the given assignment option set.

During operation 514, the digital hardware processor converts the subproblem 512 to a PBO problem 516. Operation 514 can comprise associating a binary variable with each possible assignment of an assignee to an assignment option (of the given assignment option set) within the inner optimization problem. Operation 514 can comprise iterating over each assignment option and creating a term for every combination of assignees that can be assigned to that assignment option. Additionally, operation 514 can combine the resulting terms, and can do so by adding coefficients for terms with like variables (e.g., combining 2x₁x₃x₆ and -3x₁x₃x₆ into -1x₁x₃x₆). The output of operation 514 is a PBO problem 516 for the subproblem 512, where the PBO problem is equivalent to the inner optimization problem.

For some embodiments, operation 514 starts from the inner optimization problem as defined by Error! Reference source not found., and converts the inner optimization problem into an equivalent PBO problem by introducing a pseudo-Boolean function (which is a multi-variate polynomial of binary variables) defined by the following Error! Reference source not found.:

$${\sum }_{I ⊆ \left\{1 , 2 , … , n\right\}} {α}_{I} {\prod }_{i ∈ I} {u}_{i} .$$

Here, each uᵢ is a variable that can be assigned only the values 0 or 1; I is a subset of the numbers 1 through n (the number of uᵢ variables); and α_{I} is the coefficient associated with the product of uᵢ variables over the set I of indices. For example, if I = {1, 6, 7}, then the product associated with I is u₁u₆u₇ and the coefficient of this term in the summation is a_{1,6,7}.

Additionally, to represent the inner objective function from Error! Reference source not found. in terms of a pseudo-Boolean function, operation 514 can use a logarithmic transformation to replace the product over ƒ_{i,j}(s) terms with an equivalent exponential of a summation over these terms, which results in the following Error! Reference source not found.:

$${\prod }_{j = 1}^{{M}_{i}} {f}_{i , j} \left(s\right) = e x p \left({\sum }_{j = 1}^{{M}_{i}} I n \left({f}_{i , j} \left(s\right)\right)\right) .$$

For many assignment problems, the optimal solution vectors (e.g., the optimal assignments of assignment options to assignees) can be of more interest than the optimal value of the objective function itself. In view of this, operation 514 can replace the minimization problem in Error! Reference source not found. with an argument-minimization problem as defined by the following Error! Reference source not found.:

$$\begin{matrix}{\text{argmin}}_{s ∈ {S}_{i} \left(R\right)} {\prod }_{j = 1}^{{M}_{i}} {f}_{i , j} \left(s\right) = {\text{argmin}}_{s ∈ {S}_{i} \left(R\right)} {\sum }_{j = 1}^{{M}_{i}} l n \left({f}_{i , j} \left(s\right)\right) \\ \text{subject to} C \left(s\right) \text{is true} \text{.}\end{matrix}$$

Due to the properties of exponentials, the switch to argument minimization allows the exponential to be ignored in favor of a minimization over the summation. The optimal solution vectors for Error! Reference source not found. and Equation 8 can remain identical as long as ƒ_{i,j}(s) > 0 for all functions ƒ_{i,j} from the original optimization problem and all valid solutions s. Additionally, once an optimal solution vector has been identified, the optimal value of the original objective function can be computed if desired.

Before detailing the conversion to the PBO problem, consider the example partitioning and restriction set illustrated in FIG. 3. As described herein, the assignment option set Yᵢ under consideration can remain fixed throughout the inner optimization problem. For illustrative purposes, the following description considers an example for the restriction R₁ and partition Y_{B}. In this example, the possible assignments associated with partition Y_{B} restricted by R₁ is given by

$${E}_{B}^{{R}_{1}} = \left\{{e}_{4} = \left({x}_{2} , {y}_{2}\right) , {e}_{5} = \left({x}_{2} , {y}_{3}\right) , {e}_{6} =\right)$$

$$\left(\left({x}_{3} , {y}_{2}\right) , {e}_{7} = \left({x}_{3} , {y}_{3}\right)\right\} .$$

Further, we define

$${S}_{i}^{r}$$

to be the set of all possible assignments for partition Yᵢ given an assignment restriction r. The following Table 1 enumerates the set S_{B}(R₁) - the set of all possible assignments for partition Y_{B} given restriction R₁ - and assign an identifier sₘ to each partial solution in this set.

TABLE 1

| | | |
|---|---|---|
| s₁ = {e₄, e₅, e₆, e₇} | s₆ = {e₄, e₅} | s₁₂ = {e₄} |
| s₂ = {e₄, e₅, e₆} | s₇ = {e₄, e₆} | s₁₃ = {e₅} |
| s₃ = {e₄, e₅, e₇} | s₈ = {e₄, e₇} | s₁₄ = {e₆} |
| s₄ = {e₄, e₆, e₇} | s₉ = {e₅, e₆} | s₁₅ = {e₇} |
| s₅ = {e₅, e₆, e₇} | s₁₀ = {e₅, e₇} | s₁₆ = ø |
| | s₁₁ = {e₆,e₇} | |

Each possible solution sₘ is associated with at least one term in the pseudo-Boolean function as follows. For each possible assignment eₙ from the complete, original problem (e.g., not from any partitioned sub-problem), the binary variable uₙ associated with eₙ is introduced. For each possible solution sₘ, let sₘ(j) be the sub-solution associated with option yⱼ only. For instance, the sub-solution of s₁ associated with y₂ is s₁(2) = {e₄, e₆} . Other sub solutions in our example include s₁(3) = {e₅, e₇}, s₂(2) = {e₄, e₆}, and s₂(3) = {e₅}. For each sub-solution sₘ(j), we introduce the term

$${α}_{I}^{j} {Π}_{n ∈ I} {u}_{n}$$

where the product is over the variables associated with assignments in sₘ(j) and

$${α}_{I}^{j}$$

is given by the following Error! Reference source not found.:

$${α}_{I}^{j} = l n \left({f}_{\text{i,j}} \left(I\right)\right) .$$

For instance, s₁(2) is associated with I = {4,6} and the term

$${α}_{4 , 6}^{2} {u}_{4} {u}_{6}$$

where

$${α}_{4 , 6}^{2} = ln \left({\text{f}}_{\text{B,2}} \left(\left\{{e}_{4} , {e}_{6}\right\}\right)\right) .$$

Likewise, s₂(3) is associated with I = 5 and the term

$${α}_{5}^{3} {u}_{5}$$

where

$${α}_{5}^{3} = l n \left({f}_{\text{B,3}} \left(\left\{{e}_{5}\right\}\right)\right) .$$

If these terms are part of the pseudo-Boolean function to optimize, then whenever both u₄ and u₆ are assigned the value 1 the coefficient

$${α}_{4 , 6}^{2}$$

will show up in the sum of the objective function. Whenever either or both of u₄ and u₆ are assigned the value 0, the coefficient

$${α}_{4 , 6}^{2}$$

will not show up in the sum of the objective function. Typically, the assignment option yⱼ in question can be uniquely determined from the set of edge indices I and the j index can be omitted from the notation of the alpha coefficients, leaving a₁. However, in certain cases - in particular, when I is equal to the empty-set - the j index must be included. In this empty-set case, there are no corresponding assignment edges and the respective alpha term

$${α}_{\text{O}}^{j}$$

becomes a constant in the summation shown in Error! Reference source not found.. For I ≠ Ø, we use the notation a_{I} and

$${α}_{I}^{j}$$

interchangeably.

Because there can be overlap among solutions, it will be common for a sub-solution of one possible solution to be the same as a sub-solution of another possible solution. Some examples of this can be seen in the example problem, such as s₁(2) = s₂(2) = {e₄, e₆} . Accordingly, generating the α_{I} Π_{n∈I} uₙ terms exactly coincide with the collection of all subsets of assignees that can be assigned to a common option (rather than coming from iterating through all possible solutions and sub-solutions).

For the example, operation 514 can examine the set of all possible assignments E to find the set of assignees that can be assigned to option y₂ is {x₂, x₃}. The subsets of this set of assignees are Ø, {x₂}, {x₃}, and {x₂, x₃}. For each of these sub-solutions, there is a corresponding

$${α}_{I}^{j}$$

term. For example, the sub-solution {x₂, x₃} corresponds to the assignment edges {e₄, e₆} and the term

$${α}_{4 , 6}^{2} {u}_{4} {u}_{6}$$

where

$${α}_{4 , 6}^{2} = l n \left({f}_{B \text{,2}} \left(\left\{{e}_{4} , {e}_{6}\right\}\right)\right) .$$

For the solution corresponding to the empty-set, there are no related assignment edges and the associated term becomes the constant

$${α}_{\text{O}}^{j} = l n \left({f}_{A , 2} \left(\text{O}\right)\right) .$$

With respect to the pseudo-Boolean formulation, this method of constructing terms can give rise to the problem of multiple counting. For example, we desire the coefficient α_{2,5} to show up in the sum of the objective function when u₂ and u₅ are both assigned the value 1, but not when u₂, u₄, and u₅ are all assigned the value 1. To remedy this, operation 514 can modify the coefficients according to the following Error! Reference source not found.:

$${α}_{I}^{j , ∗} = l n \left({f}_{i , j} \left(\left\{{e}_{n} : n ∈ I\right\}\right)\right) - {\sum }_{J ⊆ I} {α}_{J}^{j , ∗} .$$

Here,

$${α}_{I}^{j , ∗}$$

is the same as

$${α}_{I}^{j}$$

as previously defined whenever I is the empty-set since there are no non-equal subsets of the empty-set. Whenever I is not the empty-set, we start with the previously defined

$${α}_{I}^{j}$$

and subtract all the coefficients corresponding to subsets of I. Notice that all the coefficients

$${α}_{2 , 4 , 6}^{∗} ,$$

$${α}_{4 , 6}^{∗} , {α}_{2 , 6}^{∗} , {α}_{2 , 4}^{∗} , {α}_{6}^{∗} , {α}_{2}^{∗} , \text{and} {α}_{\text{O}}^{j , ∗}$$

still show up in the sum of the objective function whenever u₂, u₄, and u₆ are all assigned the value 1. However, the sum of these terms is the desired value

$${α}_{2 , 4 , 6} = l n \left({f}_{A , 2} \left({e}_{2} , {e}_{4} , {e}_{6}\right)\right)$$

because all the remaining values sum to zero.

The objective function for this sub-problem can now be converted by operation 514 to a pseudo-Boolean function. To do this, we use the notation I_{*},ⱼ to indicate the set of possible assignment indices for assignments involving option yⱼ. For example, I_{∗,2} corresponds to the set of possible assignment edges for option y₂, which is {e₂, e₄, e₆}, and thus I_{∗,2} = (2, 4, 6}. With this, the pseudo-Boolean version of the inner objective function can be defined by the following Error! Reference source not found.:

$${\sum }_{j ∈ {Y}_{i}} {\sum }_{\text{I} ⊆ {\text{I}}_{* , \text{j}}} {a}_{I}^{j , ∗} {\prod }_{n ∈ I} {u}_{n} .$$

The PBO problem 516 of the inner optimization problem (of the subproblem 512) can then be stated as the following Error! Reference source not found., where Ui(R) is the set of all binary assignment vectors for partition Yᵢ given restriction R, B^{m} is the set of ordered, binary m-tuples, and C′(u) is an equivalent statement of the constraints described by C(s) for the binary representation u:

$$\begin{matrix}{\text{argmin}}_{u ∈ {U}_{i} \left(R\right)} {\sum }_{j ∈ {Y}_{i}} {\sum }_{\text{I} ⊆ {\text{I}}_{* , \text{j}}} {a}_{I}^{j , ∗} {\prod }_{n ∈ I} {u}_{n} \text{subject to} \\ u ∈ {m}^{} , {C}^{′} \left(u\right) \text{is true} \text{.}\end{matrix}$$

At operation 518, the digital hardware processor determines a PBO solution for the PBO problem 516. Operation 518 can comprise applying an optimization technique suitable for constrained optimization over a pseudo-Boolean objective function. For example, the pseudo-Boolean optimization problem 516 as defined by Error! Reference source not found. can be solved using any technique suitable for constrained pseudo-Boolean optimization, such as an exhaustive search, a quantum computer-based solver (e.g., quantum annealing), simulated annealing, or a variable neighborhood search. Where quantum annealing is the selected solution technique, the PBO problem can be converted to a Quadratic Unconstrained Binary Optimization (QUBO) problem. This can involve one or both of (1) constraint relaxation, where all constraints properties that must be satisfied are incorporated directly into the objective function as penalty terms; and (2) degree reduction, where the degree of the objective function is reduced to quadratic (e.g., with Freedman and/or Ishikawa reduction techniques). The output of operation 518 is a solution to the PBO problem, which can be converted back to a solution to the inner optimization problem of the subproblem 512 by operation 520.

Subsequently, at operation 522, the digital hardware processor determines whether any assignment option sets remain for consideration by operation 510 and, if so, the method 500 returns to operation 510, where operation 510 is performed (for the current chosen restriction) with respect to another chosen assignment option set (one not previously considered). If no assignment option sets remain for consideration by operation 510 (e.g., all partite sets have been considered), the method 500 can proceed to operation 524.

At operation 524, the digital hardware processor combines each of the subproblem solutions that result from operation 520 together into a combined (or complete) solution for the restriction optimization problem 508. For instance, operation 526 can combine the individual solutions to each inner optimization problem into one complete solution comprising all assignment option sets (e.g., all partite sets) for the current restriction R chosen by 506 and its corresponding restriction optimization problem 508. The output of operation 524 is the combined (or complete) solution, which can represent one complete evaluation of the restriction objective function.

Eventually, at operation 526, the digital hardware processor determines whether any restrictions (of the set of restrictions) remain for consideration by the method 500 and, if so, the method 500 returns to operation 506, where another restriction (not previously considered) is chosen by operation 506. If all restrictions have been considered, the method 500 exits to the end.

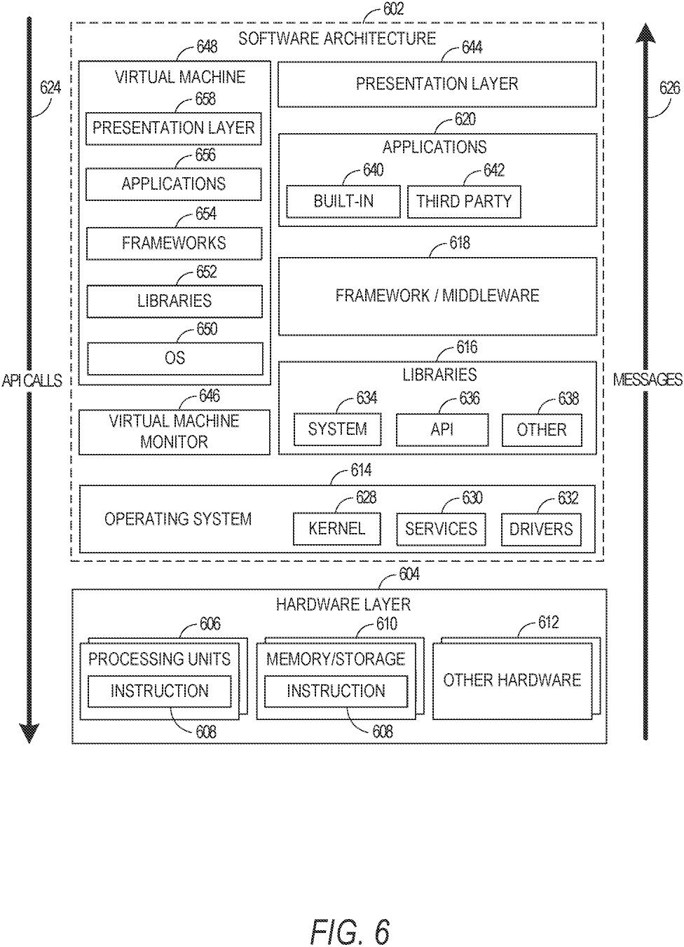

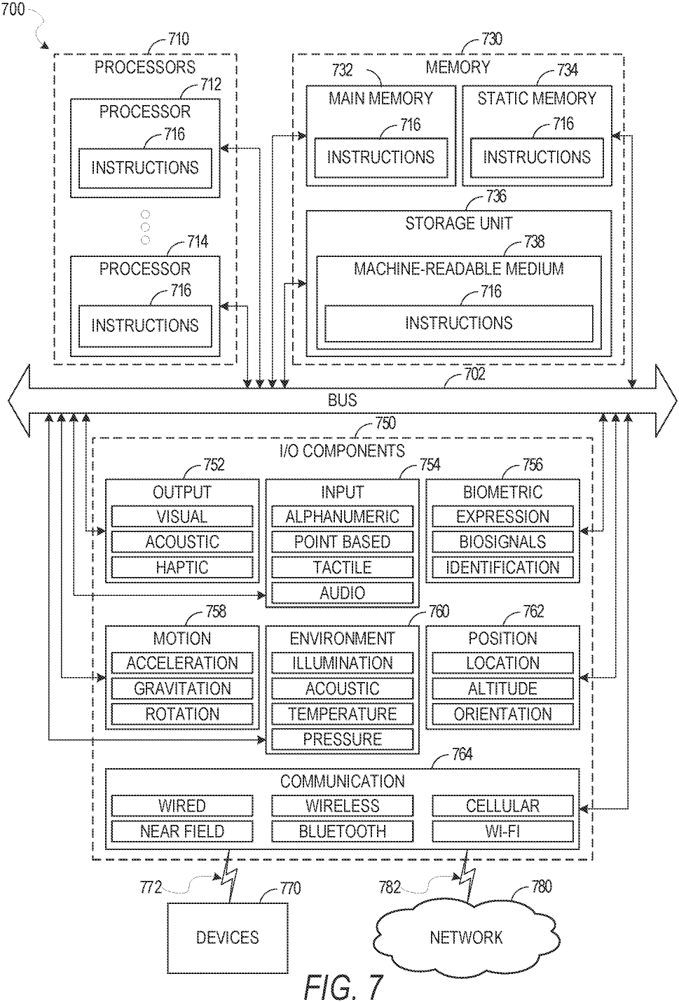

FIG. 6 is a block diagram illustrating an example of a software architecture 602 that may be installed on a machine, according to some example embodiments. FIG. 6 is merely a non-limiting example of software architecture, and it will be appreciated that many other architectures may be implemented to facilitate the functionality described herein. The software architecture 602 may be executing on hardware such as a machine 700 of FIG. 7 that includes, among other things, processors 710, memory 730, and input/output (I/O) components 750. A representative hardware layer 604 is illustrated and can represent, for example, the machine 700 of FIG. 7. The representative hardware layer 604 comprises one or more processing units 606 having associated executable instructions 608. The executable instructions 608 represent the executable instructions of the software architecture 602. The hardware layer 604 also includes memory or storage modules 610, which also have the executable instructions 608. The hardware layer 604 may also comprise other hardware 612, which represents any other hardware of the hardware layer 604, such as the other hardware illustrated as part of the machine 700.

In the example architecture of FIG. 6, the software architecture 602 may be conceptualized as a stack of layers, where each layer provides particular functionality. For example, the software architecture 602 may include layers such as an operating system 614, libraries 616, frameworks/middleware 618, applications 620, and a presentation layer 644. Operationally, the applications 620 or other components within the layers may invoke API calls 624 through the software stack and receive a response, returned values, and so forth (illustrated as messages 626) in response to the API calls 624. The layers illustrated are representative in nature, and not all software architectures have all layers. For example, some mobile or special-purpose operating systems may not provide a frameworks/middleware 618 layer, while others may provide such a layer. Other software architectures may include additional or different layers.

The operating system 614 may manage hardware resources and provide common services. The operating system 614 may include, for example, a kernel 628, services 630, and drivers 632. The kernel 628 may act as an abstraction layer between the hardware and the other software layers. For example, the kernel 628 may be responsible for memory management, processor management (e.g., scheduling), component management, networking, security settings, and so on. The services 630 may provide other common services for the other software layers. The drivers 632 may be responsible for controlling or interfacing with the underlying hardware. For instance, the drivers 632 may include display drivers, camera drivers, Bluetooth^{®} drivers, flash memory drivers, serial communication drivers (e.g., Universal Serial Bus (USB) drivers), Wi-Fi^{Ⓡ} drivers, audio drivers, power management drivers, and so forth depending on the hardware configuration.

The libraries 616 may provide a common infrastructure that may be utilized by the applications 620 and/or other components and/or layers. The libraries 616 typically provide functionality that allows other software modules to perform tasks in an easier fashion than by interfacing directly with the underlying operating system 614 functionality (e.g., kernel 628, services 630, or drivers 632). The libraries 616 may include system libraries 634 (e.g., C standard library) that may provide functions such as memory allocation functions, string manipulation functions, mathematic functions, and the like. In addition, the libraries 616 may include API libraries 636 such as media libraries (e.g., libraries to support presentation and manipulation of various media formats such as MPEG4, H.264, MP3, AAC, AMR, JPG, and PNG), graphics libraries (e.g., an OpenGL framework that may be used to render 2D and 3D graphic content on a display), database libraries (e.g., SQLite that may provide various relational database functions), web libraries (e.g., WebKit that may provide web browsing functionality), and the like. The libraries 616 may also include a wide variety of other libraries 638 to provide many other APIs to the applications 620 and other software components/modules.

The frameworks 618 (also sometimes referred to as middleware) may provide a higher-level common infrastructure that may be utilized by the applications 620 or other software components/modules. For example, the frameworks 618 may provide various graphical user interface functions, high-level resource management, high-level location services, and so forth. The frameworks 618 may provide a broad spectrum of other APIs that may be utilized by the applications 620 and/or other software components/modules, some of which may be specific to a particular operating system or platform.

The applications 620 include built-in applications 640 and/or third-party applications 642. Examples of representative built-in applications 640 may include, but are not limited to, a home application, a contacts application, a browser application, a book reader application, a location application, a media application, a messaging application, or a game application.

The third-party applications 642 may include any of the built-in applications 640, as well as a broad assortment of other applications. In a specific example, the third-party applications 642 (e.g., an application developed using the Android™ or iOS™ software development kit (SDK) by an entity other than the vendor of the particular platform) may be mobile software running on a mobile operating system such as iOS™, Android™, or other mobile operating systems. In this example, the third-party applications 642 may invoke the API calls 624 provided by the mobile operating system such as the operating system 614 to facilitate functionality described herein.

The applications 620 may utilize built-in operating system functions (e.g., kernel 628, services 630, or drivers 632), libraries (e.g., system libraries 634, API libraries 636, and other libraries 638), or frameworks/middleware 618 to create user interfaces to interact with users of the system. Alternatively, or additionally, in some systems, interactions with a user may occur through a presentation layer, such as the presentation layer 644. In these systems, the application/module “logic” can be separated from the aspects of the application/module that interact with the user.

Some software architectures utilize virtual machines. In the example of FIG. 6, this is illustrated by a virtual machine 648. The virtual machine 648 creates a software environment where applications/modules can execute as if they were executing on a hardware machine (e.g., the machine 700 of FIG. 7). The virtual machine 648 is hosted by a host operating system (e.g., the operating system 614) and typically, although not always, has a virtual machine monitor 646, which manages the operation of the virtual machine 648 as well as the interface with the host operating system (e.g., the operating system 614). A software architecture executes within the virtual machine 648, such as an operating system 650, libraries 652, frameworks/middleware 654, applications 656, or a presentation layer 658. These layers of software architecture executing within the virtual machine 648 can be the same as corresponding layers previously described or may be different.

FIG. 7 illustrates a diagrammatic representation of a machine 700 in the form of a computer system within which a set of instructions may be executed for causing the machine 700 to perform any one or more of the methodologies discussed herein, according to an embodiment. Specifically, FIG. 7 shows a diagrammatic representation of the machine 700 in the example form of a computer system, within which instructions 716 (e.g., software, a program, an application, an applet, an app, or other executable code) for causing the machine 700 to perform any one or more of the methodologies discussed herein may be executed. For example, the instructions 716 may cause the machine 700 to execute the method 400 described above with respect to FIG. 4 or the method 500 described above with respect to FIG. 5. The instructions 716 transform the general, non-programmed machine 700 into a particular machine 700 programmed to carry out the described and illustrated functions in the manner described. In alternative embodiments, the machine 700 operates as a standalone device or may be coupled (e.g., networked) to other machines. In a networked deployment, the machine 700 may operate in the capacity of a server machine or a client machine in a server-client network environment, or as a peer machine in a peer-to-peer (or distributed) network environment. The machine 700 may comprise, but not be limited to, a server computer, a client computer, a personal computer (PC), a tablet computer, a laptop computer, a netbook, a personal digital assistant (PDA), an entertainment media system, a cellular telephone, a smart phone, a mobile device, or any machine capable of executing the instructions 716, sequentially or otherwise, that specify actions to be taken by the machine 700. Further, while only a single machine 700 is illustrated, the term “machine” shall also be taken to include a collection of machines 700 that individually or jointly execute the instructions 716 to perform any one or more of the methodologies discussed herein.

The machine 700 may include processors 710, memory 730, and I/O components 750, which may be configured to communicate with each other such as via a bus 702. In an embodiment, the processors 710 (e.g., a digital hardware processor, such as a central processing unit (CPU), a reduced instruction set computing (RISC) processor, a complex instruction set computing (CISC) processor, a graphics processing unit (GPU), a digital signal processor (DSP), an application-specific integrated circuit (ASIC), a radio-frequency integrated circuit (RFIC), another processor, or any suitable combination thereof) may include, for example, a processor 712 and a processor 714 that may execute the instructions 716. The term “processor” is intended to include multi-core processors that may comprise two or more independent processors (sometimes referred to as “cores”) that may execute instructions contemporaneously. Although FIG. 7 shows multiple processors 710, the machine 700 may include a single processor with a single core, a single processor with multiple cores (e.g., a multi-core processor), multiple processors with a single core, multiple processors with multiples cores, or any combination thereof.

The memory 730 may include a main memory 732, a static memory 734, and a storage unit 736 including machine-readable medium 738, each accessible to the processors 710 such as via the bus 702. The main memory 732, the static memory 734, and the storage unit 736 store the instructions 716 embodying any one or more of the methodologies or functions described herein. The instructions 716 may also reside, completely or partially, within the main memory 732, within the static memory 734, within the storage unit 736, within at least one of the processors 710 (e.g., within the processor’s cache memory), or any suitable combination thereof, during execution thereof by the machine 700.

The I/O components 750 may include a wide variety of components to receive input, provide output, produce output, transmit information, exchange information, capture measurements, and so on. The specific I/O components 750 that are included in a particular machine will depend on the type of machine. For example, portable machines such as mobile phones will likely include a touch input device or other such input mechanisms, while a headless server machine will likely not include such a touch input device. It will be appreciated that the I/O components 750 may include many other components that are not shown in FIG. 7. The I/O components 750 are grouped according to functionality merely for simplifying the following discussion, and the grouping is in no way limiting. In various embodiments, the I/O components 750 may include output components 752 and input components 754. The output components 752 may include visual components (e.g., a display such as a plasma display panel (PDP), a light-emitting diode (LED) display, a liquid crystal display (LCD), a projector, or a cathode ray tube (CRT)), acoustic components (e.g., speakers), haptic components (e.g., a vibratory motor, resistance mechanisms), other signal generators, and so forth. The input components 754 may include alphanumeric input components (e.g., a keyboard, a touch screen configured to receive alphanumeric input, a photo-optical keyboard, or other alphanumeric input components), point-based input components (e.g., a mouse, a touchpad, a trackball, a joystick, a motion sensor, or another pointing instrument), tactile input components (e.g., a physical button, a touch screen that provides location and/or force of touches or touch gestures, or other tactile input components), audio input components (e.g., a microphone), and the like.

In further embodiments, the I/O components 750 may include biometric components 756, motion components 758, environmental components 760, or position components 762, among a wide array of other components. The motion components 758 may include acceleration sensor components (e.g., accelerometer), gravitation sensor components, rotation sensor components (e.g., gyroscope), and so forth. The environmental components 760 may include, for example, illumination sensor components (e.g., photometer), temperature sensor components (e.g., one or more thermometers that detect ambient temperature), humidity sensor components, pressure sensor components (e.g., barometer), acoustic sensor components (e.g., one or more microphones that detect background noise), proximity sensor components (e.g., infrared sensors that detect nearby objects), gas sensors (e.g., gas detection sensors to detect concentrations of hazardous gases for safety or to measure pollutants in the atmosphere), or other components that may provide indications, measurements, or signals corresponding to a surrounding physical environment. The position components 762 may include location sensor components (e.g., a Global Positioning System (GPS) receiver component), altitude sensor components (e.g., altimeters or barometers that detect air pressure from which altitude may be derived), orientation sensor components (e.g., magnetometers), and the like.

Communication may be implemented using a wide variety of technologies. The I/O components 750 may include communication components 764 operable to couple the machine 700 to a network 780 or devices 770 via a coupling 782 and a coupling 772, respectively. For example, the communication components 764 may include a network interface component or another suitable device to interface with the network 780. In further examples, the communication components 764 may include wired communication components, wireless communication components, cellular communication components, near field communication (NFC) components, Bluetooth^{®} components (e.g., Bluetooth^{®} Low Energy), Wi-Fi^{®} components, and other communication components to provide communication via other modalities. The devices 770 may be another machine or any of a wide variety of peripheral devices (e.g., a peripheral device coupled via a USB).

Moreover, the communication components 764 may detect identifiers or include components operable to detect identifiers. For example, the communication components 764 may include radio frequency identification (RFID) tag reader components, NFC smart tag detection components, optical reader components (e.g., an optical sensor to detect one-dimensional bar codes such as Universal Product Code (UPC) bar code, multi-dimensional bar codes such as Quick Response (QR) code, Aztec code, Data Matrix, Dataglyph, MaxiCode, PDF417, Ultra Code, UCC RSS-2D bar code, and other optical codes), or acoustic detection components (e.g., microphones to identify tagged audio signals). In addition, a variety of information may be derived via the communication components 764, such as location via Internet Protocol (IP) geolocation, location via Wi-Fi® signal triangulation, location via detecting an NFC beacon signal that may indicate a particular location, and so forth.

Certain embodiments are described herein as including logic or a number of components, modules, elements, or mechanisms. Such modules can constitute either software modules (e.g., code embodied on a machine-readable medium or in a transmission signal) or hardware modules. A “hardware module” is a tangible unit capable of performing certain operations and can be configured or arranged in a certain physical manner. In various example embodiments, one or more computer systems (e.g., a standalone computer system, a client computer system, or a server computer system) or one or more hardware modules of a computer system (e.g., a processor or a group of processors) are configured by software (e.g., an application or application portion) as a hardware module that operates to perform certain operations as described herein.

In some embodiments, a hardware module is implemented mechanically, electronically, or any suitable combination thereof. For example, a hardware module can include dedicated circuitry or logic that is permanently configured to perform certain operations. For example, a hardware module can be a special-purpose processor, such as a field-programmable gate array (FPGA) or an ASIC. A hardware module may also include programmable logic or circuitry that is temporarily configured by software to perform certain operations. For example, a hardware module can include software encompassed within a general-purpose processor or other programmable processor. It will be appreciated that the decision to implement a hardware module mechanically, in dedicated and permanently configured circuitry, or in temporarily configured circuitry (e.g., configured by software) can be driven by cost and time considerations.

Accordingly, the phrase “module” should be understood to encompass a tangible entity, be that an entity that is physically constructed, permanently configured (e.g., hardwired), or temporarily configured (e.g., programmed) to operate in a certain manner or to perform certain operations described herein. Considering embodiments in which hardware modules are temporarily configured (e.g., programmed), each of the hardware modules need not be configured or instantiated at any one instance in time. For example, where a hardware module comprises a general-purpose processor configured by software to become a special-purpose processor, the general-purpose processor may be configured as respectively different special-purpose processors (e.g., comprising different hardware modules) at different times. Software can accordingly configure a particular processor or processors, for example, to constitute a particular hardware module at one instance of time and to constitute a different hardware module at a different instance of time.

Hardware modules can provide information to, and receive information from, other hardware modules. Accordingly, the described hardware modules can be regarded as being communicatively coupled. Where multiple hardware modules exist contemporaneously, communications can be achieved through signal transmission (e.g., over appropriate circuits and buses) between or among two or more of the hardware modules. In embodiments in which multiple hardware modules are configured or instantiated at different times, communications between or among such hardware modules may be achieved, for example, through the storage and retrieval of information in memory structures to which the multiple hardware modules have access. For example, one hardware module performs an operation and stores the output of that operation in a memory device to which it is communicatively coupled. A further hardware module can then, at a later time, access the memory device to retrieve and process the stored output Hardware modules can also initiate communications with input or output devices, and can operate on a resource (e.g., a collection of information).

The various operations of example methods described herein can be performed, at least partially, by one or more processors (e.g., digital hardware processors) that are temporarily configured (e.g., by software) or permanently configured to perform the relevant operations. Whether temporarily or permanently configured, such processors constitute processor-implemented modules that operate to perform one or more operations or functions described herein. As used herein, “processor-implemented module” refers to a hardware module implemented using one or more processors.

Similarly, the methods described herein can be at least partially processor-implemented, with a particular processor or processors being an example of hardware. For example, at least some of the operations of a method can be performed by one or more processors or processor-implemented modules. Moreover, the one or more processors may also operate to support performance of the relevant operations in a “cloud computing” environment or as a “software as a service” (SaaS). For example, at least some of the operations may be performed by a group of computers (as examples of machines 700 including processors 710), with these operations being accessible via a network (e.g., the Internet) and via one or more appropriate interfaces (e.g., an API). In certain embodiments, for example, a client device may relay or operate in communication with cloud computing systems, and may access circuit design information in a cloud environment.

The performance of certain of the operations may be distributed among the processors, not only residing within a single machine 700, but deployed across a number of machines 700. In some example embodiments, the processors 710 or processor-implemented modules are located in a single geographic location (e.g., within a home environment, an office environment, or a server farm). In other example embodiments, the processors or processor-implemented modules are distributed across a number of geographic locations.

### Executable Instructions and Machine Storage Medium

The various memories (i.e., 730, 732, 734, and/or the memory of the processor(s) 710) and/or the storage unit 736 may store one or more sets of instructions 716 and data structures (e.g., software) embodying or utilized by any one or more of the methodologies or functions described herein. These instructions (e.g., the instructions 716), when executed by the processor(s) 710, cause various operations to implement the disclosed embodiments.

As used herein, the terms “machine-storage medium,” “device-storage medium,” and “computer-storage medium” mean the same thing and may be used interchangeably. The terms refer to a single or multiple storage devices and/or media (e.g., a centralized or distributed database, and/or associated caches and servers) that store executable instructions 716 and/or data. The terms shall accordingly be taken to include, but not be limited to, solid-state memories, and optical and magnetic media, including memory internal or external to processors. Specific examples of machine-storage media, computer-storage media and/or device-storage media include non-volatile memory, including by way of example semiconductor memory devices, e.g., erasable programmable read-only memory (EPROM), electrically erasable programmable read-only memory (EEPROM), FPGA, and flash memory devices; magnetic disks such as internal hard disks and removable disks; magneto-optical disks; and CD-ROM and DVD-ROM disks. The terms “machine-storage media,” “computer-storage media,” and “device-storage media” specifically exclude carrier waves, modulated data signals, and other such media, at least some of which are covered under the term “signal medium” discussed below.

### Transmission Medium

In various embodiments, one or more portions of the network 780 may be an ad hoc network, an intranet, an extranet, a virtual private network (VPN), a LAN, a wireless LAN (WLAN), a WAN, a wireless WAN (WWAN), a metropolitan-area network (MAN), the Internet, a portion of the Internet, a portion of the public switched telephone network (PSTN), a plain old telephone service (POTS) network, a cellular telephone network, a wireless network, a Wi-Fi® network, another type of network, or a combination of two or more such networks. For example, the network 780 or a portion of the network 780 may include a wireless or cellular network, and the coupling 782 may be a Code Division Multiple Access (CDMA) connection, a Global System for Mobile communications (GSM) connection, or another type of cellular or wireless coupling. In this example, the coupling 782 may implement any of a variety of types of data transfer technology, such as Single Carrier Radio Transmission Technology (1 xRTT), Evolution-Data Optimized (EVDO) technology, General Packet Radio Service (GPRS) technology, Enhanced Data rates for GSM Evolution (EDGE) technology, third Generation Partnership Project (3GPP) including 3G, fourth generation wireless (4G) networks. Universal Mobile Telecommunications System (UMTS), High-Speed Packet Access (HSPA), Worldwide Interoperability for Microwave Access (WiMAX), Long-Term Evolution (LTE) standard, others defined by various standard-setting organizations, other long-range protocols, or other data transfer technology.

The instructions may be transmitted or received over the network using a transmission medium via a network interface device (e.g., a network interface component included in the communication components) and utilizing any one of a number of well-known transfer protocols (e.g., hypertext transfer protocol (HTTP)). Similarly, the instructions may be transmitted or received using a transmission medium via the coupling (e.g., a peer-to-peer coupling) to the devices 770. The terms “transmission medium” and “signal medium” mean the same thing and may be used interchangeably in this disclosure. The terms “transmission medium” and “signal medium” shall be taken to include any intangible medium that is capable of storing, encoding, or carrying the instructions for execution by the machine, and include digital or analog communications signals or other intangible media to facilitate communication of such software. Hence, the terms “transmission medium” and “signal medium” shall be taken to include any form of modulated data signal, carrier wave, and so forth. The term “modulated data signal” means a signal that has one or more of its characteristics set or changed in such a manner as to encode information in the signal.

### Computer-Readable Medium

The terms “machine-readable medium,” “computer-readable medium,” and “device-readable medium” mean the same thing and may be used interchangeably in this disclosure. The terms are defined to include both machine-storage media and transmission media. Thus, the terms include both storage devices/media and carrier waves/modulated data signals. For instance, an embodiment described herein can be implemented using a non-transitory medium (e.g., a non-transitory computer-readable medium).

Throughout this specification, plural instances may implement resources, components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components.

As used herein, the term “or” may be construed in either an inclusive or exclusive sense. The terms “a” or “an” should be read as meaning “at least one,” “one or more,” or the like. The presence of broadening words and phrases such as “one or more,” “at least,” “but not limited to,” “without limitation” or other like phrases in some instances shall not be read to mean that the narrower case is intended or required in instances where such broadening phrases may be absent. Additionally, boundaries between various resources, operations, modules, engines, and data stores are somewhat arbitrary, and particular operations are illustrated in a context of specific illustrative configurations. Other allocations of functionality are envisioned and may fall within a scope of various embodiments of the present disclosure. The specification and drawings are, accordingly, to be regarded in an illustrative rather than a restrictive sense.

It will be understood that changes and modifications may be made to the disclosed embodiments without departing from the scope of the present disclosure. These and other changes or modifications are intended to be included within the scope of the present disclosure.

What is claimed is:

1. A system comprising:
a memory storing instructions; and
one or more digital hardware processors communicatively coupled to the memory and configured by the instructions to perform operations comprising:
accessing a first computational problem that comprises a sum-product optimization problem that describes an assignment problem, the assignment problem comprising a plurality of assignees and a plurality of assignment options;
determining a plurality of assignment option sets from the plurality of assignment options;
determining a set of restrictions for the assignment problem, each restriction of the set of restrictions constraining each assignee of the plurality of assignees to an individual assignee option set of the plurality of assignment option sets;
determining a set of combined solutions for the first computational problem by iteratively performing operations comprising:
selecting an individual restriction from the set of restrictions; determining, from the first computational problem, a second computational problem that comprises a restriction optimization problem for the individual restriction;
determining, from the second computational problem, a set of computational subproblems each of which describes a different inner optimization subproblem of the restriction optimization problem that corresponds to a different one of the plurality of assignment option sets;
determining a set of subproblem solutions for the set of computational subproblems; and
combining the set of subproblem solutions to determine a combined solution for the second computational problem; and
determining a most optimal solution from the set of combined solutions.

2. The system of claim 1, wherein the determining the plurality of assignment option sets from the plurality of assignment options based on a decomposability property.

3. The system of claim 1, wherein the determining of the set of subproblem solutions for the set of computational subproblems comprises, for each individual computational subproblem of the of computational subproblems:
determining, based on the individual computational subproblem, a third computational problem that describes a pseudo-Boolean optimization (PBO) problem; and
solving the PBO problem to determine an individual subproblem solution of the set of subproblem solutions that corresponds to the individual computational subproblem.

4. The system of claim 3, wherein the determining of the third computational problem based on the individual computational subproblem comprises:
associating a binary variable with each possible assignment of an assignee, of an inner optimization subproblem of the individual computational subproblem, to an assignment option of the inner optimization subproblem; and
for each assignment option of the inner optimization subproblem:
determining a set of terms by determining a term for each combination of assignees that can be assigned to the assignment option; and
combining the set of terms by adding coefficients for terms of the set of terms that have like associated binary variables.

5. The system of claim 3, wherein the solving of the PBO problem to determine the individual subproblem solution comprises:
applying an optimization technique for constrained optimization of the PBO problem.

6. The system of claim 3, wherein the solving of the PBO problem to determine the individual subproblem solution comprises:
using a quantum computer-based solver to solve the PBO problem.

7. The system of claim 6, wherein the quantum computer-based solver is implemented using a quantum annealer.

8. The system of claim 6, wherein the using of the quantum computer-based solver to solve the PBO problem comprises:
converting the third computational problem to a fourth computational problem that comprises a quadratic unconstrained binary optimization (QUBO) problem; and
submitting the fourth computational problem to the quantum computer-based solver to generate the optimized solution.

9. The system of claim 3, wherein the solving of the PBO problem to determine the individual subproblem solution comprises:
Using a simulated annealing technique to solve the PBO problem.

10. The system of claim 3, wherein the solving of the PBO problem to determine the individual subproblem solution comprises:
using a neighborhood search technique to solve the PBO problem.

11. The system of claim 1, wherein the operations are iteratively performed for each restriction from the set of restrictions.

12. The system of claim 1, wherein the determining the plurality of assignment option sets from the plurality of assignment options comprises using at least one of random selection, a machine-learning model, or an application-specific technique.

13. The system of claim 1, wherein each restriction of the set of restrictions constrains each assignee of the plurality of assignees to exactly one of the plurality of assignment option sets.

14. A non-transitory computer-readable medium comprising instructions that, when executed by one or more digital hardware processors of a computing device, cause the computing device to perform operations comprising:
accessing a first computational problem that comprises a sum-product optimization problem describing an assignment problem, the assignment problem comprising a plurality of assignees and a plurality of assignment options;
determining a plurality of assignment option sets from the plurality of assignment options;
determining a set of restrictions for the assignment problem, each restriction of the set of restrictions constraining each assignee of the plurality of assignees to an individual assignee option set of the plurality of assignment option sets;
determining a set of combined solutions for the first computational problem by iteratively performing operations comprising:
selecting an individual restriction from the set of restrictions;
determining, from the first computational problem, a second computational problem that describes a restriction optimization problem for the individual restriction;
determining, from the second computational problem, a set of computational subproblems each of which describes a different inner optimization subproblem of the restriction optimization problem that corresponds to a different one of the plurality of assignment option sets;
determining a set of subproblem solutions for the set of computational subproblems; and
combining the set of subproblem solutions to determine a combined solution for the second computational problem; and
determining a most optimal solution from the set of combined solutions.

15. The non-transitory computer-readable medium of claim 14, wherein the determining the plurality of assignment option sets from the plurality of assignment options based on a decomposability property.

16. The non-transitory computer-readable medium of claim 14, wherein the determining of the set of subproblem solutions for the set of computational subproblems comprises, for each individual computational subproblem of the of computational subproblems:
determining, based on the individual computational subproblem, a third computational problem that describes a pseudo-Boolean optimization (PBO) problem; and
solving the PBO problem to determine an individual subproblem solution of the set of subproblem solutions that corresponds to the individual computational subproblem.

17. The non-transitory computer-readable medium of claim 16, wherein the determining of the third computational problem based on the individual computational subproblem comprises:
associating a binary variable with each possible assignment of an assignee, of an inner optimization subproblem of the individual computational subproblem, to an assignment option of the inner optimization subproblem; and
for each assignment option of the inner optimization subproblem:
determining a set of terms by determining a term for each combination of assignees that can be assigned to the assignment option; and
combining the set of terms by adding coefficients for terms of the set of terms that have like associated binary variables.

18. The non-transitory computer-readable medium of claim 16, wherein the solving of the PBO problem to determine the individual subproblem solution comprises:
applying an optimization technique for constrained optimization of the PBO problem.

19. The non-transitory computer-readable medium of claim 16, wherein the solving of the PBO problem to determine the individual subproblem solution comprises:
using a quantum computer-based solver to solve the PBO problem.

20. A method comprising:
accessing, by one or more digital hardware processors, a first computational problem that comprises a sum-product optimization problem describing an assignment problem, the assignment problem comprising a plurality of assignees and a plurality of assignment options;
determining, by the one or more digital hardware processors, a plurality of assignment option sets from the plurality of assignment options;
determining, by the one or more digital hardware processors, a set of restrictions for the assignment problem, each restriction of the set of restrictions constraining each assignee of the plurality of assignees to an individual assignee option set of the plurality of assignment option sets;
determining, by the one or more digital hardware processors, a set of combined solutions for the first computational problem by iteratively performing operations comprising:
selecting an individual restriction from the set of restrictions;
determining, from the first computational problem, a second computational problem that describes a restriction optimization problem for the individual restriction;
determining, from the second computational problem, a set of computational subproblems each of which describes a different inner optimization subproblem of the restriction optimization problem that corresponds to a different one of the plurality of assignment option sets;
determining a set of subproblem solutions for the set of computational subproblems; and
combining the set of subproblem solutions to determine a combined solution for the second computational problem; and
determining, by the one or more digital hardware processors, a most optimal solution from the set of combined solutions.
